(19) United States
(12) Patent Application Publication
(10) Pub. No.: US 2019/0025633 A1
(43) Pub. Date: Jan. 24, 2019

(54) LIQUID CRYSTAL DISPLAY PANEL

(71) Applicant: SHENZHEN CHINA STAR OPTOELECTRONICS SEMICONDUCTOR DISPLAY TECHNOLOGY CO., LTD., Shenzhen (CN)

(72) Inventor: Xiaowen LV, Shenzhen (CN)

(73) Assignee: SHENZHEN CHINA STAR OPTOELECTRONICS SEMICONDUCTOR DISPLAY TECHNOLOGY CO., LTD., Shenzhen (CN)

(21) Appl. No.: 15/576,823

(22) PCT Filed: Oct. 17, 2017
(86) PCT No.: PCT/CN2017/106573

§ 371 Date: Nov. 26, 2017

(30) Foreign Application Priority Data
Jul. 19, 2017 (CN) 201710592920.0

(51) Int. Cl. G02F 1/1335

(52) U.S. Cl. CPC G02F 1/133512

(57) ABSTRACT

A liquid crystal display panel includes a first substrate, a second substrate, and a light shielding layer. The first substrate includes a first display area and a first non-display area surrounding the first display area. The second substrate is opposite to the first substrate. The second substrate includes a second display area and a second non-display area surrounding the second display area. The light shielding layer overlaps at least one part of at least one of the first display area and the second display area.

### FIELD OF THE INVENTION

The present disclosure relates to the field of display technologies, and more particularly to a liquid crystal display panel.

### BACKGROUND OF THE INVENTION

Because of the wide use of liquid crystal displays as well as higher display performance requirements, tolerance for low display performance is getting lower and lower. Low image display performance is a common defect and has a large impact on liquid crystal displays. Low image display performance has many complex causes and is difficult to correct.

Low display performance on an edge of an image is generally considered light leakage, which may generally be caused by the following two reasons, one reason is design defects, and another reason is lack of technology. These two reasons are very difficult to solve. Design defects need to be re-evaluated, masks need to be re-opened, and have high costs. Lack of technology is generally lack of accuracy and uniformity, etc. It takes a long time to solve the problem of the lack of technology and solution's performance needs to be confirmed several times. If height difference between a height of a spacer disposed on an edge of a liquid crystal display and a height of a spacer disposed in a middle of the liquid crystal display being large or contaminated liquid crystal due to forming a frame, etc., may cause four edges of the liquid crystal display to have differences in brightness.

Referring to FIG. 4A, a liquid crystal display panel includes a display area 401 and a non-display area surrounding an edge of the display area 401. The non-display area includes a frame 402 surrounding the display area 401. The frame 402 fixes a substrate 403 facing the frame 402. At least one part of the edge of the display area 401 is a light spot area 404. Referring to FIG. 4B, a bottom substrate 410 includes a first display area 411 and a first non-display area 412 surrounding an edge of the first display area 411. A top substrate 420 includes a second display area 421 and a second non-display area 422 surrounding an edge of the second display area 421. The first display area 411 corresponds to the second display area 421, and a frame 430 is configured to fix and support the top substrate 420 and the bottom substrate 410. The bottom substrate 410 includes a light receiving surface. The top substrate 420 includes a light emitting surface. Display performance of the liquid crystal display panel is reduced when a light shielding material on an edge of the bottom substrate 410 cannot effectively shield light or other factors causing light spots to appear on the second display area 421.

In summary, existing liquid crystal display panels have low display performance of the edge of an image due to light spots (such as mura) appearing on the edge of the liquid crystal display panel caused by the height difference between the height of the spacer disposed on the edge of the liquid crystal display and the height of the spacer disposed in the middle of the liquid crystal display being large and contaminated liquid crystal due to forming the frame, etc., thereby affecting the display performance, reducing the display performance, and affecting liquid crystal display quality.

### SUMMARY OF THE INVENTION

An object of the present disclosure is to provide a liquid crystal display panel capable of improving light leakage in an edge of a liquid crystal display panel, making light spots on a substrate close to an edge of the liquid crystal display panel, and capable of effectively shielding the light spots, thereby improving display performance and thus liquid crystal display quality is ensured.

To achieve the above object, an embodiment of the present disclosure provides a liquid crystal display panel, which includes:

a first substrate including a first display area corresponding to a display area of the liquid crystal display panel and a first non-display area surrounding the first display area;

a second substrate opposite to the first substrate, the second substrate including a second display area corresponding to the display area of the liquid crystal display panel and a second non-display area surrounding the second display area, the first display area corresponding to the second display area;

a liquid crystal layer formed between the first substrate and the second substrate; and

a light shielding layer disposed on at least one of the first substrate and the second substrate;

wherein the light shielding layer includes a first light shielding strip disposed on the first substrate, the first light shielding strip is disposed on a side of the first non-display area close to the first display area;

wherein the light shielding layer overlaps at least one part of at least one of the first display area and the second display area.

In an embodiment of the present disclosure, an area of the second display area is greater than an area of the first display area, and the second display area covers the first display area, at least one part of an edge of the second display area extends to overlap with the first light shielding strip.

In an embodiment of the present disclosure, at least one part of the first light shielding strip near an edge of the first display area extends to overlap the at least one part of the edge of the second display area.

In an embodiment of the present disclosure, the light shielding layer further includes a second light shielding strip disposed on the second substrate, and the second light shielding strip is disposed on a surface of the second substrate having a light spot area and covers the light spot area.

In an embodiment of the present disclosure, the second light shielding strip overlaps the second display area and the first light shielding strip.

In an embodiment of the present disclosure, at least one of the first light shielding strip and the second light shielding strip is made of black light shielding material.

An embodiment of the present disclosure further provides a liquid crystal display panel, which includes:

a first substrate including a first display area corresponding to a display area of the liquid crystal display panel and a first non-display area surrounding the first display area;

a second substrate opposite to the first substrate, the second substrate including a second display area corresponding to the display area of the liquid crystal display panel and a second non-display area surrounding the second display area, the first display area corresponding to the second display area;

a liquid crystal layer formed between the first substrate and the second substrate; and

a light shielding layer disposed on at least one of the first substrate and the second substrate;

wherein the light shielding layer overlaps at least one part of at least one of the first display area and the second display area.

In an embodiment of the present disclosure, the light shielding layer includes a first light shielding strip disposed on the first substrate, the first light shielding strip is disposed on a side of the first non-display area close to the first display area.

In an embodiment of the present disclosure, an area of the second display area is greater than an area of the first display area, and the second display area covers the first display area, at least one part of an edge of the second display area extends to overlap with the first light shielding strip.

In an embodiment of the present disclosure, at least one part of the first light shielding strip near an edge of the first display area extends to overlap the at least one part of the edge of the second display area.

In an embodiment of the present disclosure, the light shielding layer further includes a second light shielding strip disposed on the second substrate, and the second light shielding strip is disposed on a surface of the second substrate having a light spot area and covers the light spot area.

In an embodiment of the present disclosure, the second light shielding strip overlaps the second display area and the first light shielding strip.

In an embodiment of the present disclosure, at least one of the first light shielding strip and the second light shielding strip is made of black light shielding material.

The embodiment of the present disclosure has the advantage that, compared to the existing liquid crystal display panel, the liquid crystal display panel of the embodiment of the present disclosure extends the edge of the second substrate so that a light spot area appearing on the second substrate is close to the edge of the second substrate and the light spot area appearing on the second substrate is shielded by the light shielding strip. It is possible to prevent the light spots from appearing in an active area (AA) of the liquid crystal display panel without changing an area and size of the active area.

### DESCRIPTION OF THE DRAWINGS

The accompanying figures to be used in description of embodiments of the present disclosure or prior art will be described in brief to more clearly illustrate the technical solutions of the embodiments or the prior art. The accompanying figures described below are only part of embodiments of the present disclosure, from which figures those skilled in the art can derive further figures without making any inventive efforts.

FIG. 1 is a schematic view illustrating a structure of a liquid crystal display panel according to a first embodiment of the present disclosure.

FIG. 2 is a schematic view illustrating a structure of another liquid crystal display panel according to the first embodiment of the present disclosure.

FIG. 3 is a schematic view illustrating a structure of a liquid crystal display panel according to a second embodiment of the present disclosure.

FIG. 4A is a schematic view illustrating a structure of a liquid crystal display panel according to the existing technology.

FIG. 4B is a schematic view illustrating a structure of a liquid crystal display panel according to the existing technology.

### DETAILED DESCRIPTION OF THE PREFERRED EMBODIMENTS

The embodiments described herein with reference to the accompanying drawings are explanatory, illustrative, and used to generally understand the present disclosure. Furthermore, directional terms described by the present disclosure, such as top, bottom, front, rear, left, right, inner, outer, side, etc., are only directions by referring to the accompanying drawings, and thus the used terms are used only for the purpose of describing embodiments of the present disclosure and are not intended to be limiting of the present disclosure. In the drawings, modules with similar structures are labeled with the same reference number.

Existing liquid crystal display panels have low display performance for edge images due to light leakage and light spots appearing on an edge of the liquid crystal display panel caused by the height difference between a height of the spacer disposed on the edge of the liquid crystal display and the height of the spacer disposed in the middle of the liquid crystal display being large and contaminated liquid crystal due to forming the frame, etc., thereby affecting liquid crystal display quality. The embodiment of the present disclosure is capable of solving the drawbacks.

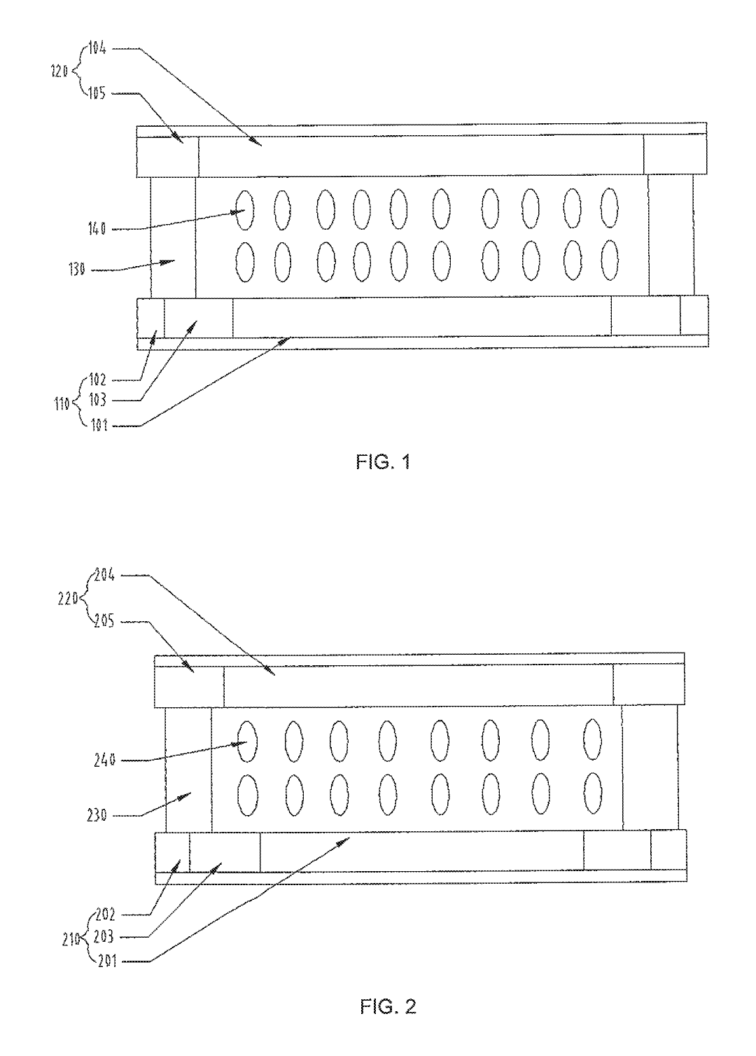

Referring to FIG. 1, a schematic view illustrating a structure of a liquid crystal display panel according to a first embodiment of the present disclosure is provided. The liquid crystal display panel includes a display area and a non-display area surrounding the display area. The liquid crystal display panel includes a first substrate 110, a second substrate 120, and a liquid crystal layer 140. The first substrate 110 includes a first display area 101 corresponding to the display area of the liquid crystal display panel and a first non-display area 102 surrounding the first display area 101. The first substrate 110 includes a light receiving surface. The second substrate 120 is opposite to the first substrate 110. The second substrate 120 includes a light emitting surface. The second substrate 120 includes a second display area 104 corresponding to the display area of the liquid crystal display panel and a second non-display area 105 surrounding the second display area 104. The first display area 101 corresponds to the second display area 104. The liquid crystal layer 140 is formed between the first substrate 110 and the second substrate 120 and is disposed in the display area of the liquid crystal display panel. The first substrate 110 further includes a first light shielding strip 103 disposed between the first display area 101 and the first non-display area 102 for shielding light in a part of an edge of the first display area 101.

The second substrate 120 includes a black matrix disposed in the second display area 104. The black matrix surrounds a pixel display area.

Due to edge light leakage caused by a height difference between a height of a spacer disposed on an edge of the liquid crystal display panel and a height of a spacer disposed on a middle of the liquid crystal display panel being large and contaminated liquid crystal due to forming a frame in a process, etc., thereby resulting in low display performance of the edge of the liquid crystal display panel. An area of the second display area 104 is increased in a manufacturing process of the second substrate 120, and at least one part of an edge of the second display area 104 extends to overlap with the first light shielding strip 103. The area of the second display area 104 is greater than an area of the first display area 101, and the first display area 101 is covered by the second display area 104. A projection of the first light shielding strip 103 on the second substrate 120 in a direction perpendicular to the second substrate 120 overlaps at least one part of the second display area 104.

The edge of the first substrate 110 and the edge of the second substrate 120 are fixed and supported by a frame 130. The area of the second display area 104 is increased, so that a light spot (such as mura) area appearing on the second substrate 120 is close to the edge of the liquid crystal display panel and the light spot area appearing on the second substrate 120 is shielded by the first light shielding strip 103. It is possible to prevent light spots from appearing in an active area (AA) of the liquid crystal display panel without changing an area and size of the active area, and the display performance is ensured.

Referring to FIG. 2, a schematic view illustrating a structure of another liquid crystal display panel according to a first embodiment of the present disclosure is provided. The liquid crystal display panel includes a display area and a non-display area surrounding the display area. The liquid crystal display panel includes a first substrate 210, a second substrate 220, and a liquid crystal layer 240. The first substrate 210 includes a first display area 201 corresponding to the display area of the liquid crystal display panel and a first non-display area 202 surrounding the first display area 101. The first substrate 210 includes a light receiving surface. The second substrate 220 is opposite to the first substrate 210. The second substrate 220 includes a light emitting surface. The second substrate 220 includes a second display area 204 corresponding to the display area of the liquid crystal display panel and a second non-display area 205 surrounding the second display area 204. The first display area 201 corresponds to the second display area 204. The liquid crystal layer 240 is formed between the first substrate 210 and the second substrate 220 and disposed in the display area of the liquid crystal display panel.

The first substrate 210 further includes a first light shielding strip 203 disposed between the first display area 201 and the first non-display area 202. At least one part of the first light shielding strip 203 near an edge of the first display area 201 extends to overlap at least one part of an edge of the second display area 204, so that an area of the second display area 204 is greater than an area of the first display area 201, and a projection of the first light shielding strip 203 on the second substrate 220 in a direction perpendicular to the second substrate 220 overlaps at least one part of the edge of the second display area 204. The edge of the first substrate 210 and the edge of the second substrate 220 are fixed and supported by a frame 230. Light of the edge of the display area of the liquid crystal display panel can be effectively shielded, and the edge light leakage is prevented without affecting the area of an active area due to the increase in the range of the first light shielding strip 203.

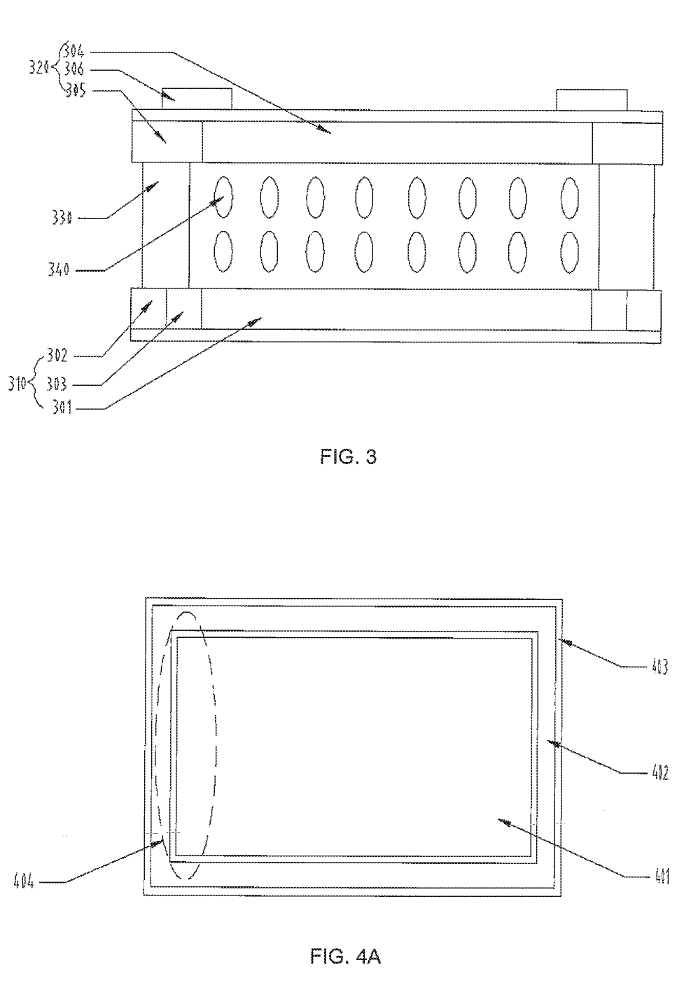

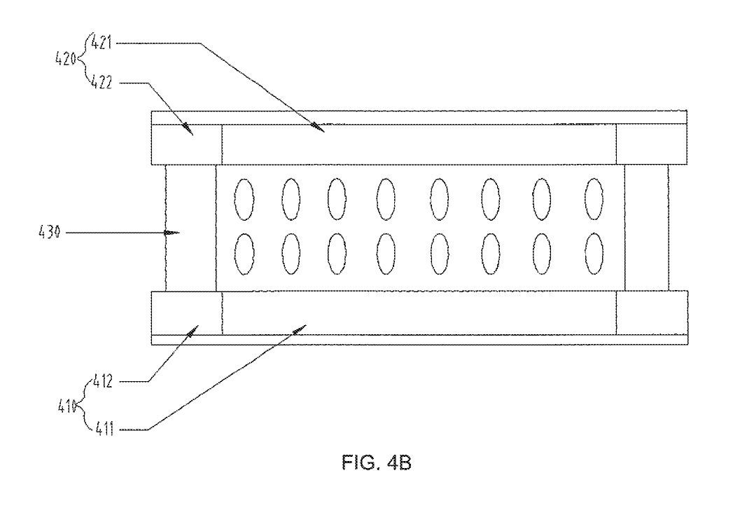

Referring to FIG. 3, a schematic view illustrating a structure of a liquid crystal display panel according to a second embodiment of the present disclosure is provided. In the embodiment, a black light shielding material is coated on a light leakage area so that edge light leakage is not visible. The liquid crystal display panel includes a first substrate 310 and a second substrate 320 opposite to the first substrate 310. The first substrate 310 includes a first display area 301 corresponding to the display area of the liquid crystal display panel and a first non-display area 302 surrounding the first display area 301. The second substrate 320 includes a second display area 304 corresponding to the display area of the liquid crystal display panel and a second non-display area 305 surrounding the second display area 304. The second substrate 320 includes a second light shielding strip 306 disposed on a surface of the second substrate 320 and covering a light spot area of the second display area 304. The second light shielding strip 306 overlaps with the second display area 304 and the first light shielding strip 303, and the first light shielding strip 303 and the light shielding strip 306 are made of black light shielding material. The edge of the first substrate 310 and the edge of the second substrate 320 are fixed and supported by a frame 330. Liquid crystal layer 340 is disposed between the first substrate 310 and the second substrate 320 and surrounded by the frame 330.

The embodiment may be subjected to a repair process by coating or other related machinery after a product quality inspection. The embodiment further prevents the edge light leakage and forms a double shielding on the liquid crystal display panel. In the case where the first light shielding strip 303 cannot completely shield edge light, a light spot area appearing in the edge of the second display area 304, the second light shielding strip 306 is disposed in the light spot area by coating or other means of repairing process, and the second light shielding strip 306 further effectively shields the edge light to prevent the light spots (such as mura) from appearing in the edge of the liquid crystal display panel. Since the second light shielding strip 306 shields the edge of the second display area 304, it is need to synchronize signals to reduce a display resolution, thereby sacrificing a part of the display resolution.

The present disclosure has been described with a preferred embodiment thereof. The preferred embodiment is not intended to limit the present disclosure, and it is understood that many changes and modifications to the described embodiment can be carried out without departing from the scope and the spirit of the invention that is intended to be limited only by the appended claims.

What is claimed is:

1. A liquid crystal display panel, comprising:
a first substrate comprising a first display area corresponding to a display area of the liquid crystal display panel and a first non-display area surrounding the first display area;
a second substrate opposite to the first substrate, the second substrate comprising a second display area corresponding to the display area of the liquid crystal display panel and a second non-display area surrounding the second display area, the first display area corresponding to the second display area;
a liquid crystal layer formed between the first substrate and the second substrate; and
a light shielding layer disposed on at least one of the first substrate and the second substrate;
wherein the light shielding layer comprises a first light shielding strip disposed on the first substrate, the first light shielding strip is disposed on a side of the first non-display area close to the first display area;
wherein the light shielding layer overlaps at least one part of at least one of the first display area and the second display area.

2. The liquid crystal display panel according to claim 1, wherein an area of the second display area is greater than an area of the first display area, and the second display area covers the first display area, at least one part of an edge of the second display area extends to overlap with the first light shielding strip.

3. The liquid crystal display panel according to claim 1, wherein at least one part of the first light shielding strip near an edge of the first display area extends to overlap the at least one part of the edge of the second display area.

4. The liquid crystal display panel according to claim 1, wherein the light shielding layer further comprises a second light shielding strip disposed on the second substrate, and the second light shielding strip is disposed on a surface of the second substrate having a light spot area and covers the light spot area.

5. The liquid crystal display panel according to claim 4, wherein the second light shielding strip overlaps the second display area and the first light shielding strip.

6. The liquid crystal display panel according to claim 5, wherein at least one of the first light shielding strip and the second light shielding strip is made of black light shielding material.

7. A liquid crystal display panel, comprising:
a first substrate comprising a first display area corresponding to a display area of the liquid crystal display panel and a first non-display area surrounding the first display area;
a second substrate opposite to the first substrate, the second substrate comprising a second display area corresponding to the display area of the liquid crystal display panel and a second non-display area surrounding the second display area, the first display area corresponding to the second display area;
a liquid crystal layer formed between the first substrate and the second substrate; and
a light shielding layer disposed on at least one of the first substrate and the second substrate;
wherein the light shielding layer overlaps at least one part of at least one of the first display area and the second display area.

8. The liquid crystal display panel according to claim 7, wherein the light shielding layer comprises a first light shielding strip disposed on the first substrate, the first light shielding strip is disposed on a side of the first non-display area close to the first display area.

9. The liquid crystal display panel according to claim 8, wherein an area of the second display area is greater than an area of the first display area, and the second display area covers the first display area, at least one part of an edge of the second display area extends to overlap with the first light shielding strip.

10. The liquid crystal display panel according to claim 8, wherein at least one part of the first light shielding strip near an edge of the first display area extends to overlap the at least one part of the edge of the second display area.

11. The liquid crystal display panel according to claim 7, wherein the light shielding layer further comprises a second light shielding strip disposed on the second substrate, and the second light shielding strip is disposed on a surface of the second substrate having a light spot area and covers the light spot area.

12. The liquid crystal display panel according to claim 11, wherein the second light shielding strip overlaps the second display area and the first light shielding strip.

13. The liquid crystal display panel according to claim 12, wherein at least one of the first light shielding strip and the second light shielding strip is made of black light shielding material.
